(19) United States
(12) Patent Application Publication
(10) Pub. No.: US 2004/0060471 A1
(43) Pub. Date: Apr. 1, 2004

(54) Device for measuring a rail segment for a magnetic levitation railway

(76) Inventor: Otmar Fahrion, Kornwestheim (DE)

Correspondence Address: King & Jovanovic, PLC, 170 College Avenue, SUITE 230, HOLLAND, MI, 49423, US

(21) Appl. No.: 10/432,963

(22) PCT Filed: Sep. 19, 2001
(86) PCT No.: PCT/EP01/10802

(30) Foreign Application Priority Data
Nov. 30, 2000 (DE) 100 59 763.7

(51) Int. Cl. B60L 13/04

(52) U.S. Cl. 104/281

(57) ABSTRACT

An apparatus for scanning a rail segment (10) for the track layout of a magnetic levitation system comprises marks (162), which are carried by an inspection unit (36) and the position of which is scanned using an electronic camera (164), which is disposed on the end of the rail segment (10). The inspection unit (36) movable along the rail segment (10) comprises a position sensor, which measures the position of the inspection unit (36) relative to one of the ends of the rail segment (10). The position of the inspection unit (10) is communicated wirelessly to an evaluating unit (168), which is further connected to the output of the electronic camera (164).

The invention relates to an apparatus for scanning a rail

segment for a magnetic levitation system. The track layouts for magnetic levitation systems are constructed from rail segments, which are prefabricated in a factory. In order to guide the levitation systems correctly also at high speeds, said rail segments have to be worked to a high degree of precision. The rail segments are in practice approximately 60 m long. In principle, the inspection of straight rail segments might still be carried out by inspection devices of a similar construction to coordinate inspection machines. In said case, however, even for straight rail segments very expensive coordinate guides would be required. The rail segments for a magnetic levitation system, however, in accordance with the respective geometry of the track layout are additionally bent (laterally (curves) and upwards and/or downwards (start and end of gradient) and moreover the rail segments at curves are additionally twisted about their longitudinal axis. In view of the costs of the inspection device, a restriction to a smaller number of standard rail segments might therefore be necessary, but this would entail concessions in terms of the track location.

By virtue of the present apparatus an inspection apparatus is to be provided, by means of which even extremely long workpieces, such as the rail segments of the track for a magnetic levitation system may be scanned economically.

Said object is achieved according to the invention by an apparatus having the features indicated in claim 1.

In the case of the apparatus according to the invention, the workpiece itself is used as a guide for an inspection unit. The latter is moved progressively preferably step by step along the workpiece in order to carry out the inspection to be effected at each point. The progressive movement of the inspection unit is effected preferably in such a way that machined points disposed in the workpiece are simultaneously used as reference points for the progressive movement of the inspection unit.

In the claims and the present description it is assumed that such machining points are recesses which are being/have been produced in the workpiece. It goes without saying that it is equally possible to use other machining results, e.g. raised portions on the workpiece, which are produced by welding or otherwise fastening material thereon, or alternatively the results of work such as local polishing or the like, which manifest themselves merely in detectable different optical properties.

The inspection unit therefore works its way along in precisely predetermined steps on the workpiece itself.

When the scanning is carried out together with a machining operation, the machining operation is effected preferably from one end of the workpiece so that, when various machined workpieces are set one after another, a correct transition in terms of the predetermined pitch is likewise guaranteed. In principle, it might however be possible to start machining the workpieces from any desired middle point of the workpiece and then check the dimensions of the workpiece in both directions towards the two ends.

According to the invention, exact determination of the position of the inspection unit, which is associated directly with the geometry of the rail segment at the point where the inspection unit is situated in each case, is effected by using at least one mark, which is carried by the inspection unit, and a camera, which generates an image of the marks.

The image may be a conventional photographic image on a film that is then later analysed by a scanner or measuring microscope. Preferably, however, an electronic camera with an image converter is used. The electrical image generated by said camera may easily be analysed electronically with regard to the position of the marks and, on the basis of the latter, with regard to the coordinates of the rail portion just inspected.

Advantageous developments of the invention are indicated in the sub-claims.

The development of the invention according to claim 2 facilitates detection of the marks.

When the marks are placed in the manner indicated in claim 3, the conversion of the position coordinates of the marks to the desired position coordinates of the rail segment is particularly easy.

The effect achieved by the development of the invention according to claim 4 is that the marks lie in the immediate vicinity of the guide surfaces of the rail segment.

The development of the invention according to claim 5 is also advantageous in view of easy assignment of the mark coordinates to the position of the inspection unit on the rail segment. Furthermore, marks disposed near the end of the inspection unit lend themselves particularly well to optical detection.

The effect achieved by the development of the invention according to claim 6 is that the inspection unit is brought to a halt at precisely predetermined points of the rail segment in order to determine the position coordinates of the rail segment there. In said manner a particularly high degree of accuracy is achieved in determining the course of the rail segment.

With the development of the invention according to claim 7 a positive precise positioning of the inspection unit at the various inspection points is achieved.

Said positioning may be effected by means of a servomotor, as indicated in claim 8. By said means the step-by-step progressive movement of the inspection unit may be configured particularly easily.

With an apparatus according to claim 9 the instantaneous position of the inspection unit on the rail segment is easily obtained.

In said case, the development of the invention according to claim 10 has the advantage that the inspection unit need not be connected by cables to the evaluation unit. Given the considerable length of the rail segments, elaborate cable guides or the like would have to be provided for cable connections.

With an apparatus according to claim 11 the data quantity arising as a whole for scanning the rail segment is small and is directly assignable to the corresponding design data of the rail segment, which as a rule are likewise created with corresponding rasterization.

When according to claim 12 the inspection unit is part of a machining unit, the scanning of a rail segment may be effected simultaneously with machining thereof.

The effect achieved by the development of the invention according to claim 13 is that the undercarriage centres itself automatically in transverse direction to the workpiece longitudinal direction.

According to claim 14 very good positioning with low spring excursions may be achieved even for the usually very heavy machining unit (a machining unit of the type used in practice to machine rail segments of a magnetic levitation system may have e.g. six milling machines and six drilling machines).

The development of the invention according to claim 15 allows the self-centring of the undercarriage onto the two lateral surfaces of the rail segment to be effected correctly even in portions where the main surface of the workpiece is inclined relative to the horizontal and weights are additionally involved.

An apparatus according to claim 16 may effect the weight compensation for portions of a rail segment that are inclined in one or the other rolling direction.

According to claim 17 compensation of the influence of the weight of the machining unit upon the centring operation may be effected automatically.

The control signal specifying said compensation may according to claim 18 easily be derived from the output signal of an inclination sensor.

Alternatively, according to claim 19 the compensation control signal may be derived from the output signal of a position sensor carried by the undercarriage, e.g. in that by means of said signal a read-only memory is addressed, in which are filed the inclinations—known from design data of the workpiece—of the main surface portions in dependence upon their distance from the workpiece end.

The effect achieved by the development of the invention according to claim 20 is that the data needed to control the machining operations are available to the machining unit without the machining unit having to be connected by a long cable to an operation controller.

An apparatus, such as is indicated in claim 21, lends itself particularly well to the production in the workpiece of precise transverse grooves having a predetermined profile. Such transverse grooves in a mounting rail of a rail segment for a magnetic levitation system are used to suspend laminated stator cores, into which are inserted the field coils that generate the magnetic field carrying the magnetically levitated vehicle.

The development of the invention according to claim 22 makes it possible to produce in the workpiece a regular pattern of bores that are used e.g. to mount fastening means. Such fastening means are used in rail segments for a magnetic levitation system to fix the laminated cores, which are inserted into the recesses, in their position.

The development of the invention according to claim 23 is advantageous in view of an overall short machining time of the workpiece.

The development of the invention according to claim 24 allows the various milling machines and drilling machines to be used for different purposes. For instance, the milling machines arranged successively in tool longitudinal direction may first be provided with identical cutters and then the machining unit after each work cycle is moved on by the length of the entire group, or the milling machines may be equipped with different cutters, e.g. for rough milling, intermediate milling and fine milling, and the machining unit is then moved on in each case only by the distance of a single recess.

The development of the invention according to claim 25 enables the use of the machining apparatus also on workpieces that are curved and/or twisted to a greater extent.

Given the use of not just a single positioning means but, for the sake of safety and accuracy, a plurality of positioning means arranged successively in workpiece longitudinal direction, said positioning means may according to claim 26 equally be provided on a separate undercarriage in order to enable the machining of workpieces that are curved and/or twisted to a greater extent.

The effect achieved by the development of the invention according to claim 27 is that machining inaccuracies stemming from the bending and/or twisting are avoided by the flexible joint between the individual undercarriages.

The development of the invention according to claim 28 allows the workpieces to be completely machined right up to their ends. It is moreover possible to park the heavy machining unit in the immediate vicinity of the actual work area and without the aid of lifting means while a finished workpiece is exchanged for a fresh one.

In a machining apparatus according to claim 29 the machining unit runs under exactly identical conditions over the end of the workpiece. This is advantageous for the accuracy of machining of the end recesses.

The development of the invention according to claim 30 allows the parking parts to be connected evenly and smoothly to the ends of the workpiece.

The development of the invention according to claim 31 is advantageous in view of the low cost of the base units for the parking parts, because these do not have to be specially designed and may be taken substantially without modification from the stock of base units needed in any case to support the workpiece.

There now follows a detailed description of embodiments of the invention with reference to the drawings. Said drawings show:

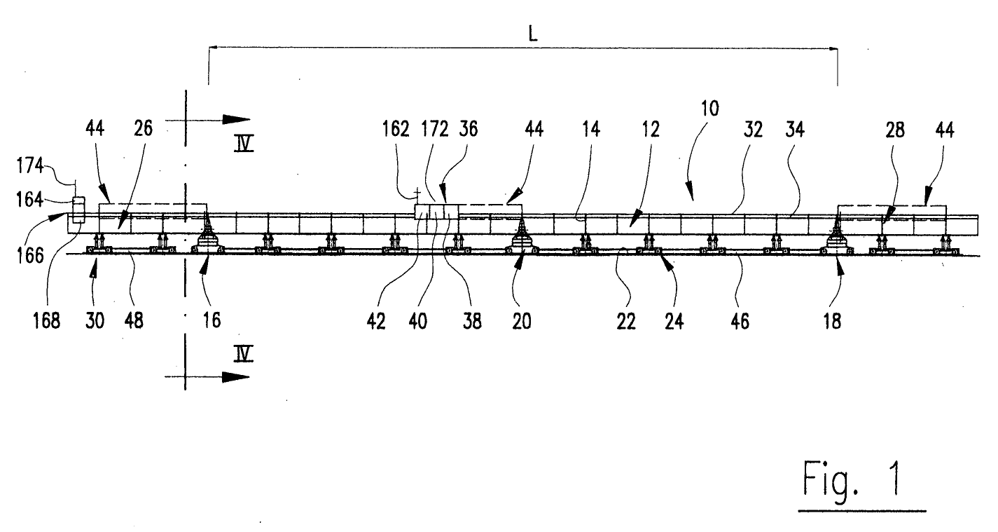

FIG. 1: a side view of an apparatus for machining and scanning the stator mounting rail of a rail segment for a magnetic levitation system;

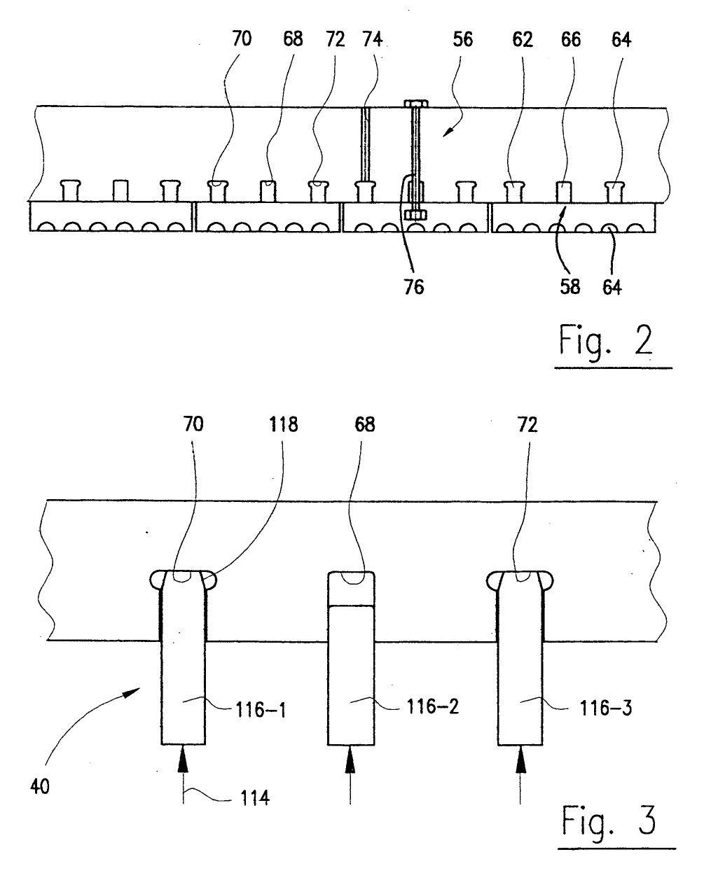

FIG. 2: a side view of a portion of the stator mounting rail of the rail segment according to FIG. 1 with several stator segments suspended therein;

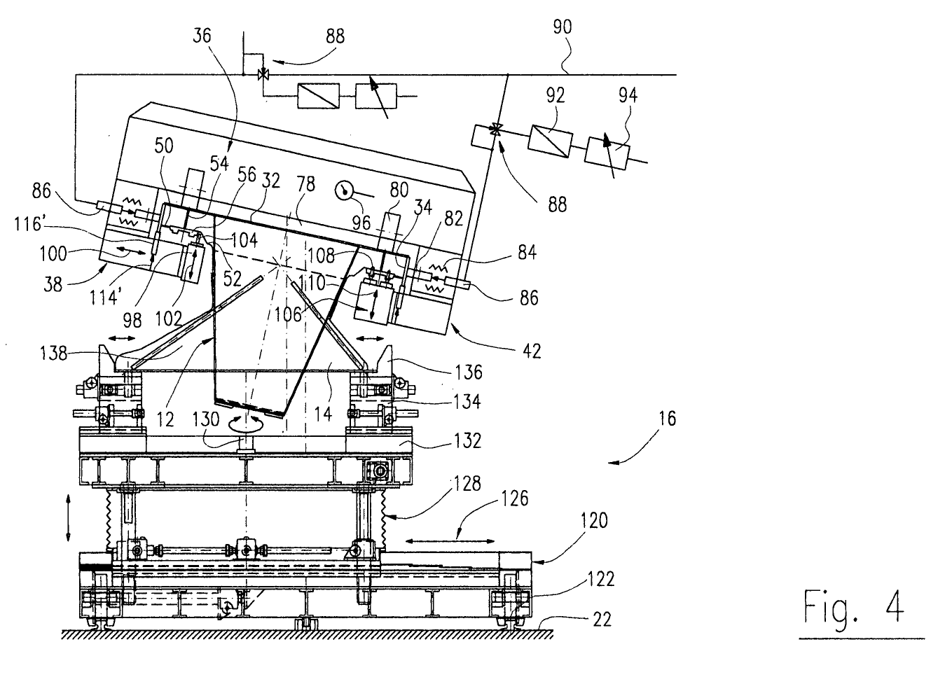

FIG. 3: a detail from a portion of the stator mounting rail according to FIG. 2, wherein a positioning unit is additionally shown;

FIG. 4: a transverse section through the machining apparatus shown in FIG. 1 along the cutting line IV-IV of FIG. 1;

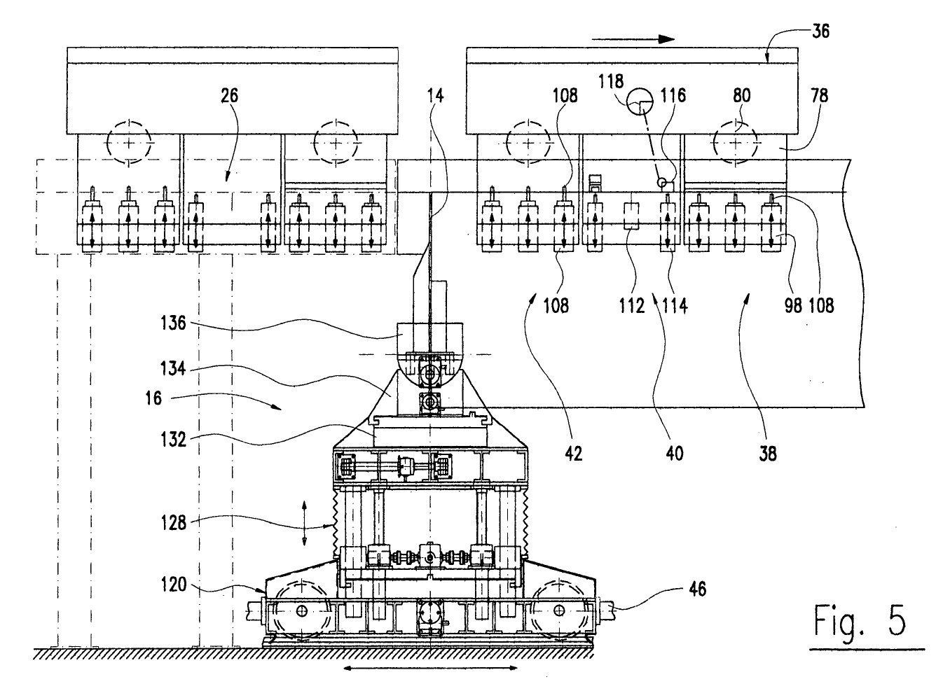

FIG. 5: a side view of a support for a workpiece end as well as a support for a parking part, which continues the rail segment;

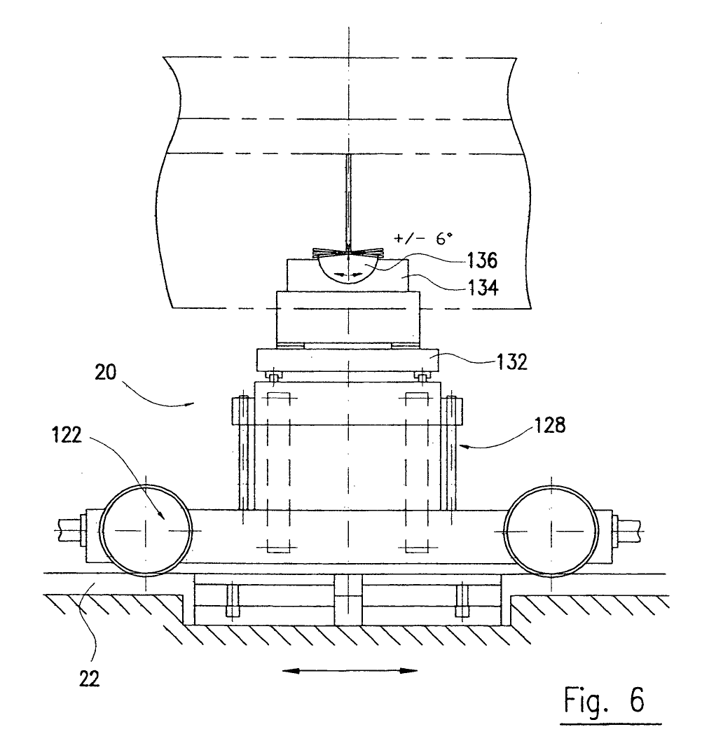

FIG. 6: a side view of a support for the middle of the rail segment, such as is used in the machining apparatus according to FIG. 1;

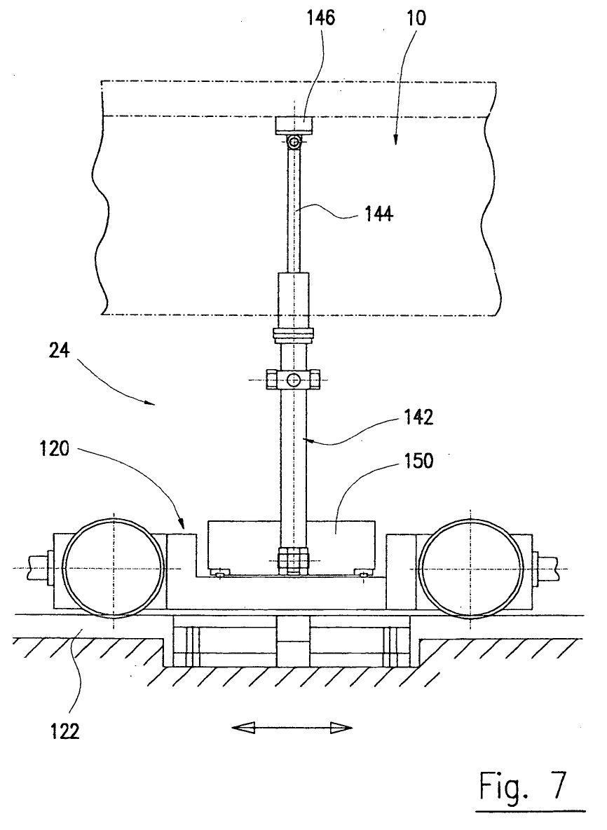

FIG. 7: a side view of a further base unit, such as is used at intermediate points of the rail segment for support and vibration-damping purposes;

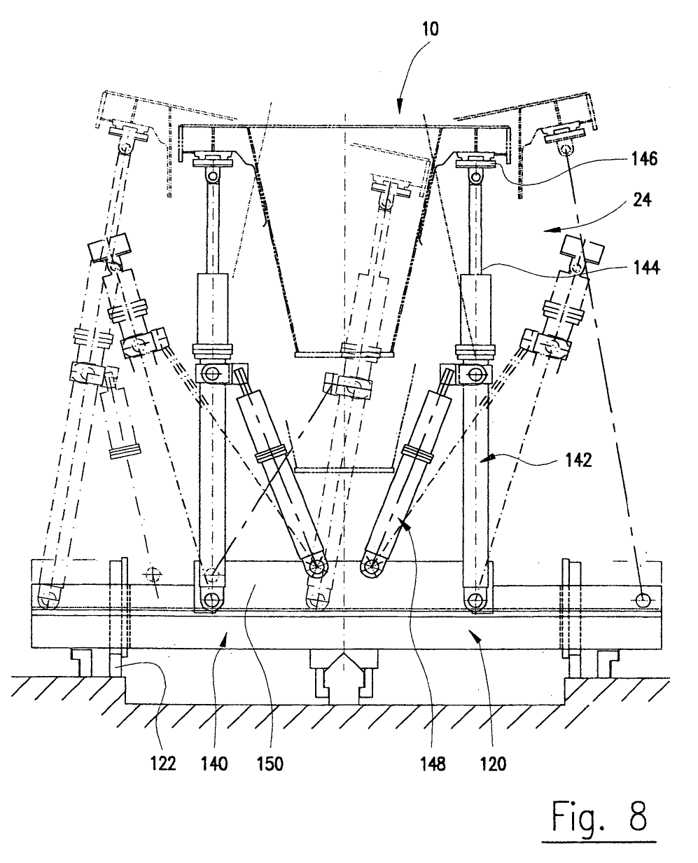

FIG. 8: a view of the base unit according to FIG. 7 in longitudinal direction of the workpiece;

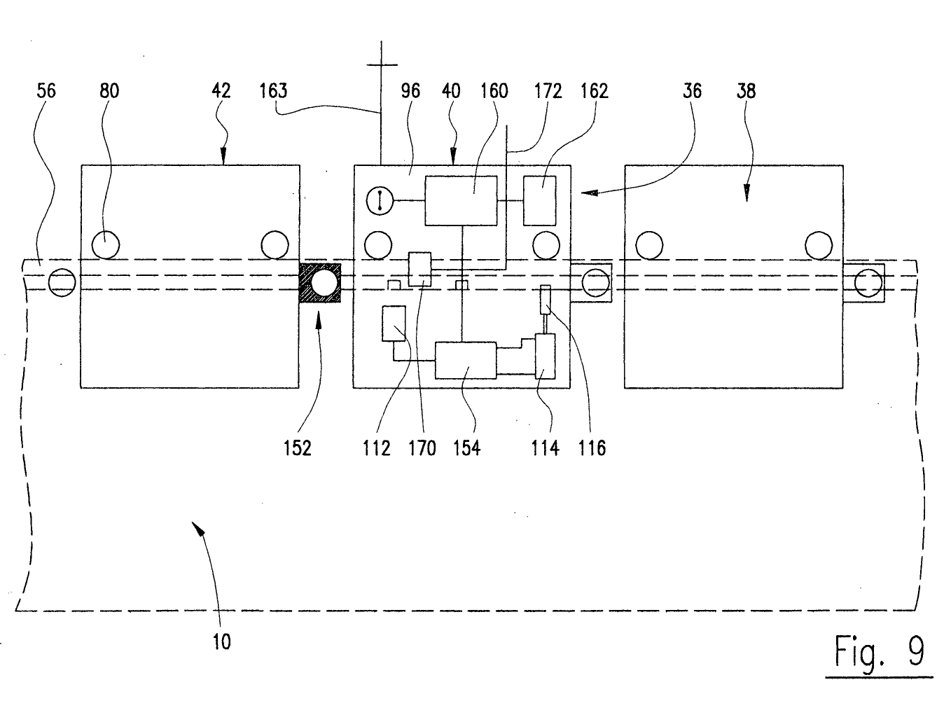

FIG. 9: a diagrammatic side view of a modified inspection and machining unit for use in the inspection and machining apparatus according to FIG. 1;

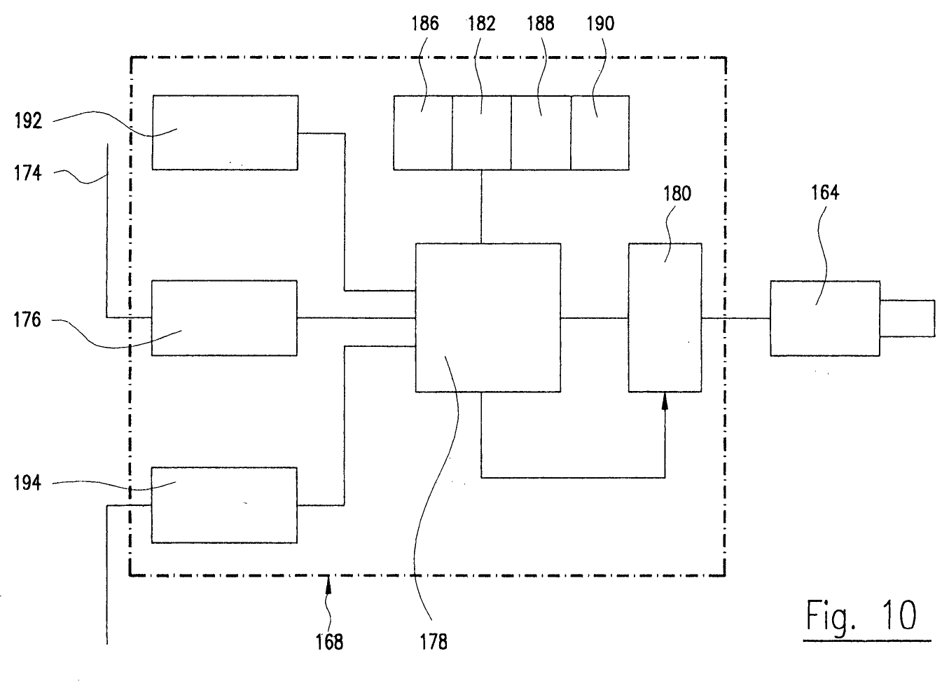

FIG. 10: a block diagram of an evaluation unit, which is part of an apparatus for scanning a rail segment;

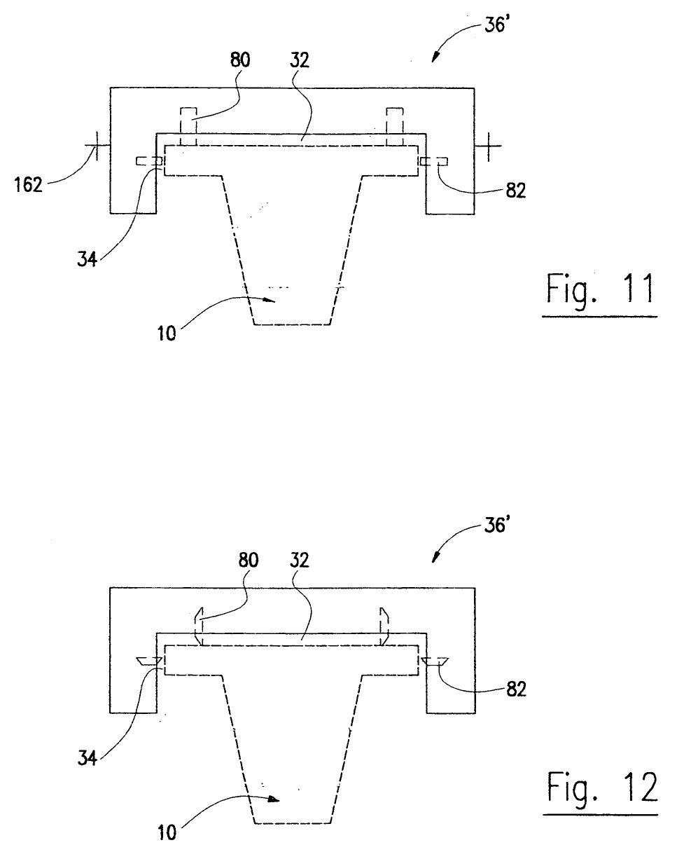

FIG. 11: a plan view of the end face of a modified inspection unit, which is shown on a rail segment, and

FIG. 12: a view similar to FIG. 11, which shows a further modified inspection unit.

In FIG. 1 a rail segment, which is used to realize the travel way of a magnetic levitation system, is denoted as a whole by 10. The total length of the rail segment, which is denoted by L in FIG. 1, is typically 60 m.

The rail segment 10 comprises a closed box section 12, onto which reinforcing plates 14 are welded at intervals of approximately 3 m.

The rail segment 10 is supported via two end base units 16, 18 and a middle base unit 20 on a factory hall floor denoted by 22. Further intermediate base units 24 support the rail segment 10 at, in each case, four intermediate points lying between adjacent base units.

The base units 16-20 correspond to support points for the rail segment, such as are also provided in the finished track layout, the intermediate base units 24 are used as additional support for the rail segment 10 for a machining operation and to damp vibrations arising during the machining operation.

At each end of the rail segment 10 a parking segment 26 and/or 28 is provided, which is carried in each case by two base units 30, which correspond in their construction substantially to the intermediate base units 24 but enable fixing of the associated parking segment 26, 28.

As is evident from FIG. 1, the base units 30 of the parking segments 26, 28 are offset inwards in each case by a grid dimension from the segment ends, thereby achieving symmetrically freely projecting end portions of the parking segments 26, 28 that are connectable evenly and smoothly to the ends of the rail segment 10. The parking segments 26, 28 are of exactly the same cross section and the same construction as a rail segment 10, being however only shorter. By constructing the parking segments 26, 28 symmetrically relative to a transverse centre plane it is guaranteed that the base units 30 associated with them do not have to absorb tilting moments in the unloaded state of the parking segment.

The rail segment 10, the structure of which is described in greater detail below, has a top horizontal main wall 32 and vertical side walls 34 extending down from its side edges.

A machining unit denoted as a whole by 36 is shown running along the rail segment 10 and is composed of three sub-units, namely a milling unit 38, a positioning unit 40 and a drilling unit 42. The structure of the machining unit 36 is described in greater detail later.

Where required, a plurality of machining units 36 may be flexibly marshalled into a train and/or larger machining unit, as indicated by dashes at 44. The length of the parking segments 26, 28 is such that there is room on them for the entire train 44, so that on completion of the machining of a rail segment 10 a train 44 may be parked, substantially without a change of height and without the aid of lifting tools or the like, in order to remove the finished rail segment 10 and insert a fresh rail segment for machining. The parking segments 26, 28 moreover allow the rail segment 10 to be machined right up to its end faces, as will be described in greater detail.

As is evident from FIG. 1, the base units 16, 18, 24 are connected preferably in a flexible manner by coupling rods 46 situated between them.

The base units 30 are connected to one another, not however to the adjacent base unit 16 and/or 18, by a coupling rod 48.

As is apparent from FIG. 4, the box section 12 is welded together from a plurality of steel plates. Emanating from the bottom portions of the side walls 34 are transverse plates 50. The plates 50 are welded via vertical intermediate plates 54 to the lateral regions of the main wall 32.

Welded to the plates 50 and the intermediate plates 54 are stator mounting rails 56. The latter comprise a continuous rolled steel section.

The inner ends of the mounting rails 56 are connected by bent metal sheets 52 in a sealed manner to the side walls of the box section 12.

In order to suspend laminated stator cores in the stator mounting rails 56, the mounting rails 56 are provided with grooves of the type illustrated in detail in FIG. 2.

This shows stator cores 58, which comprise a plurality of laminated stator segments stacked one behind the other in a direction at right angles to the drawing plane of FIG. 2. Provided in the undersides of the stator cores 58 are transverse receiving grooves 60, which subsequently receive the conductors of the field winding of the linear magnet carrying the magnetically levitated vehicle.

At the top, each stator core has two end mounting portions 62, 64, which have a substantially T-shaped cross section. A middle positioning portion 66 has a rectangular cross section.

In a corresponding manner, for each stator core one positioning groove 68 and two mounting grooves 70, 72 disposed on either side thereof are provided in the underside of the mounting rail 56. The positioning groove 68 is an exact fit for the positioning portion 66 of the stator cores 58 in order to position the latter exactly in longitudinal direction of the mounting rail 56. The mounting grooves 60, 62 correspond in cross section to the cross section of the mounting portions 62, 64, but with less sliding play, so that the stator cores 58 may be inserted into the mounting rail 56 in a lateral direction, i.e. a direction extending at right angles to the drawing plane in FIG. 2.

In order to be able to produce the various grooves 68, 70, 72 in the mounting rails 56, and moreover to be able to produce in the mounting rail through-bores 74, at which the stator cores 58 after being slipped on may be secured by means of screws 76, the travelling machining unit 36 is moved step by step along the rail segment 10. As will be described in greater detail below, the machining unit 36 is designed in such a way that during each machining step it produces one set of grooves 68, 70, 72 and one set of through-bores 74.

As is evident from FIGS. 4 and 5, the travelling machining unit 36 has a U-shaped frame 78 lapping over the top portion of the rail segment 10. In the base portion of the frame 78 four support rollers 80 are rotatable about axes extending parallel to the main wall 32 and transversely relative to the longitudinal direction of the rail segment 10 (the latter is at right angles to the drawing plane of FIG. 4).

Cooperating with the side walls 34 are four guide rollers 82, which rotate about axes lying perpendicular to the plane of the main wall 32.

The bearing blocks (not illustrated in detail) for the return rollers 82 are preloaded in the direction of the adjacent side wall 34 by diagrammatically indicated cup spring stacks 84. Said bearing blocks are additionally subject to an adjustable force, which are generated by pneumatic cylinders 86.

Whilst the cup spring stacks 84 are all of an identical construction, it is possible by varying the pressure load of the pneumatic cylinders 86 to compensate the weight component of the machining unit 36 that is obtained when the main wall 32 is inclined relative to the horizontal, as shown in FIG. 4. For said purpose, the working chambers of the pneumatic cylinders 86 acting as pneumatic springs are connectable in each case by a controllable pressure regulator 88 to a compressed-air line 90.

The pressure regulator 88 has an adjustable control pressure, which may be realized e.g. by loading its regulating body with a variable additional force, which is provided by a magnet 92 supplied with variable current, as indicated by a variable resistor 94. The resistor 94 may be a programmable resistor, which is electrically controllable, or a slide resistor or the like, which may be adjusted by means of a servomotor. In any case, by applying an electrical signal the pressure of the air supplied to the pneumatic cylinders 86 may be adjusted.

The control signals for the controllable pressure regulators 88 may either be derived from production data of the rail segment 10, which indicate for each point of the rail segment the inclination of the main wall 32 (e.g. relative to a segment end). Alternatively, the inclination of the machining unit 36 may be measured by an inclination sensor 96, which is disposed on the machining unit 36 and provides a corresponding output signal.

The milling unit 32 comprises on either side of the rail segment 10 three milling heads 98, which are disposed at identical intervals in longitudinal direction and are displaceable in transverse direction by means of a servo drive (not shown in detail), in the manner indicated by an arrow 100. The milling heads 98 are moreover displaceable in axial direction, in the manner indicated by an arrow 102.

If required, the milling heads 98 are additionally displaceable in a direction at right angles to the drawing plane of FIG. 4 (workpiece longitudinal direction) if no work involving profiling cutters is to be carried out.

Cutters 104 clamped into the milling heads 98 have a silhouette corresponding to the silhouette of the type of groove (mounting groove or positioning groove) required in each case.

The drilling unit 42 has on either side of the rail segment a multiple drilling head 106 with six spindles, each of which carries a drill bit 108, by means of which a through-bore 74 may be produced. The structure of the multiple drilling heads 106 is selected in accordance with the drill-hole pitch pattern of the stator mounting rail 56. The multiple drilling heads 106 are displaceable by means of a servo drive (not shown in detail) in a direction at right angles to the main wall 32, in the manner indicated by an arrow 110.

The positioning unit 40 comprises a groove detector 112, which may be formed e.g. by a television camera and a downstream electronic image analysis device. The groove detector 112 produces an output signal when it is situated above a previously produced groove.

When said output signal is received, positioning parts 116 are moved into grooves situated above them by pneumatic cylinders 114. An overall positioning of the machining unit 36 therefore occurs. Thus, by virtue of orientation by grooves which have just been produced, the machining unit 30 may be moved on by increments corresponding exactly to one pitch of the mounting rail 54 (i.e. to the length of a stator core 58).

FIG. 5 shows an embodiment of the positioning unit 40, in which two positioning parts 116 are provided, which cooperate in each case with one of the mounting grooves 60, 72. When the groove detector 112 is disposed in such a way that it cooperates with the right or the left end face of the mounting rail 56, a positioning part 116 and an associated pneumatic cylinder 114 may be provided also for the positioning groove 66 of a set of grooves.

Given more than one positioning part 116, one of the positioning parts is worked in such a way that it fits absolutely without play into the associated groove. To avoid redundancy, the other positioning parts are worked with slight play, as is shown in an exaggerated manner in FIG. 3.

The positioning parts 116 each have a feed slant 118, as is illustrated also in the detail enlargement of FIG. 5.

The feed slants 118 of the outer positioning parts 116-1 and 116-3 of FIG. 3 are longer than that of the middle positioning part 116-2. The latter has a shorter length than the positioning parts 116-1 and 116-3. Thus, the positioning parts 116-1 and 116-3, which first come into engagement, extensively align the positioning unit 40 and hence the machining unit 35 with the grooves 70 and 72, before the positioning part 116-2 together with the groove 68 then effects the final fine-positioning.

As is evident from FIGS. 4 and 5, the base unit 16 (and analogously the base units 18 and 20) has an undercarriage 120, which is displaceable along rails 122 let into the floor of the factory hall. The undercarriage 120 via a transverse slide 126, which is not to be described in detail here, carries a vertical adjustment unit 120. The latter via a pivot bearing 122 having a vertical axis of rotation carries a bearing trough 124. The latter has a circular bearing surface and with the latter supports a receiving table 126, which at the underside has a complementary bearing surface. On the receiving table 126 foot portions of end plates 130, which are provided on the ends of the rail segment 10, are positioned by means of transversely displaceable claws 128.

It is evident that by said means the end of a rail segment is adjustable in height and inclination in any desired manner in order that a curved and possibly twisted rail segment 10 may be received.

While in the case of the base units 16 and 18 the end plates 130 are transversely positioned only between the correspondingly positioned claws 128, the claws 128 of the middle base unit are pressed firmly against a middle fastening plate, corresponding to the end plate 130, of the rail segment 10 so that the latter is absolutely fixed at said point.

As is apparent from FIGS. 7 and 8, the base units 24 have an undercarriage 140, which likewise runs along the rails 122 and carries in a pivotal manner hydraulic cylinders 142. The piston rods 144 of the latter carry tilting support plates 146, which cooperate with the underside of a stator mounting rail 56.

The hydraulic cylinders 142 are pivotable on the undercarriage 140 about an axis parallel to the workpiece longitudinal axis and their inclination is adjustable by means of further hydraulic cylinders 148. In said manner the position of the support plates 146 may be adapted to the setpoint position and setpoint inclination of the associated mounting rail 56, as indicated by dashed lines in FIG. 8.

A lateral adjustability of the support plates 146 may additionally be achieved by travelling of a base block 150 on the undercarriage 140 in lateral direction.

The base units 30 for the parking segments 26 and 28 are of a very similar construction to the base units 24 (alternatively also 20) except that fastening means are provided there for connecting the support plates 146 firmly to the mounting rails 56.

The machining apparatus described above operates as follows:

First, the machining unit 36 is parked on one of the parking segments 26, 28, e.g. on the parking segment 26. Then a rail segment 10 is placed onto the base units 16, 18 and 20, wherein the claws 136 of the latter are adjusted in height and inclination and in their angular position about the vertical axis, as specified for the corresponding points of the rail segment in the production data of the respective rail segment 10.

Then the various base units 24 are successively adjusted likewise in such a way that the positions specified in the production data are reached at the corresponding points of the rail segment 10. On completion of said adjustment operations, the claws 136 of the base unit 20 are pressed firmly against the fastening plate, which is situated near the middle of the rail segment and corresponds in its geometry to an end plate 138.

The two parking segments 26 and 28 are then adjusted by suitable loading of the various hydraulic cylinders 142 and 148 with pressure medium in such a way that each parking segment with its top and its side surfaces forms a-uniform and smooth continuation of the adjacent end of the rail segment 10. Said adjustment of the hydraulic cylinders may be effected automatically by a control computer based on the production data for the rail segment to be machined in each case.

As the parking segments 26 and 28 totally correspond in their construction to the construction of a short inner segment, their mounting rails 56 likewise have positioning grooves 68 and mounting grooves 70, 72. These are used at the start of machining as reference marks for the groove detector 112 and the positioning parts 116.

The machining unit is first moved by one pitch (i.e. the distance between one positioning groove 68 and the next positioning groove and/or the distance between successive groups of grooves) along the rail segment 10, i.e. given the assumed initial state, to the right in FIG. 1.

The milling heads 102 are then set in operation and moved in transverse direction. As a result, a set of grooves 68, 70, 72 is produced in each of the two mounting rails 56.

The milling heads 102 are then set laterally alongside the mounting rails 56, and the machining unit 36 is moved one pitch further along the rail segment 10. The positioning unit 40 of the machining unit 36 is then situated over the grooves 68 to 72 just produced and may use them to reposition the machining unit 36 exactly, in the manner described above with reference to the parking segment 26. A second set of grooves 68 to 72 is then produced in the mounting rails 56. On completion of the latter, the machining unit 36 is moved one pitch further to the right, with the result that the positioning unit 40 again comes to lie over the grooves just newly produced. In addition, the multiple drilling heads 106 are now situated above the grooves produced during the last-but-one step.

In the next machining cycle a set of grooves 68 to 72 is again produced in the two mounting rails 56. At the same time, however, a set of through-holes 74 may also be produced by the multiple drilling heads 106.

At the end of this cycle the machining unit 36 is again moved one pitch further, and the cycle last described is repeated. All of this continues until the machining unit 36 runs off the, in FIG. 1, right end of the rail segment 10 onto the parking segment 28. During the last two work cycles, in which the milling heads 102 are already situated above the parking segment 28, the milling heads remain switched off. And during the last work cycle, in which only the last through-holes 74 are produced in the right end of the rail segment 10, the positioning unit 40 is already using the grooves in the right parking segment 28 to position the multiple drilling head 106.

If it is desired that during the last work cycle drilling of the through-bores is effected using, not reference marks carried by the parking segment 28, but newly produced grooves instead, the positioning unit 40 may in a modification alternatively be disposed downstream of the drilling unit 42, i.e. to the left thereof in FIG. 1.

Especially when a large number of milling-cutter spindles and drilling spindles are disposed successively in workpiece longitudinal direction on the machining unit 36, the machining unit 36 becomes relatively long. This may lead to problems with rail segments which are curved and/or twisted to a greater extent.

The machining unit may then be subdivided into a plurality of sub-units, e.g. three sub-units corresponding to the milling unit 38, the positioning unit 40 and the drilling unit 42. In the embodiment according to FIG. 9 such units are connected in each case by a coupling 152, which comprises a ball-and-socket joint. Thus, the individual sub-units may rotate in any desired manner in space relative to one another.

It goes without saying that each of the sub-units then has an individual frame and separate sets of support rollers 80 and guide rollers 82, as described above for the machining unit 36 as a whole.

The position of the couplings 152 is selected such that the hinge point is aligned with the neutral axis of the plane defined by the centres of the grooves 68, 70, 72. Thus, the swivelling motion of the individual sub-units leads only to very slight variations in the operation of the milling-cutters and drill bits.

FIG. 9 additionally shows an arithmetic and control unit 154, which analyses the image of the optical groove detector 112 and via which the loading of a pneumatic cylinder 114 with pressure medium is effected.

An arithmetic unit 160 is additionally provided in the positioning unit 140 and cooperates with a mass storage device 162, in which are filed the production data for the rail segment just machined, in particular the inclination of the main wall 32 in both directions in space (transverse and longitudinal inclination). These data are filed in the mass storage device 162 with a resolution, which is at least as good as the pitch of the mounting rails 56.

The arithmetic and control unit 154 acts upon the arithmetic unit 160 with pulses which it produces each time the groove detector 112, after the machining unit 36 has been moved one pitch further, discovers a groove used to align the machining unit 36. Thus, the arithmetic unit 160 knows exactly at which point the machining unit 36 is actually situated.

The arithmetic unit 160 is further shown connected to the inclination sensor 96. It is therefore able to calculate both from the output signal of the inclination sensor 96 and from the position of the machining unit 36 and the production data filed in the mass storage device 162 the additional pneumatic compensation force required at one of the pneumatic cylinders 86 to compensate the weight-related asymmetry of the self-centring of the machining unit 36 onto the rail segment 10. The arithmetic and control unit produces an electrical signal suitable for said purpose, according to which the magnets 92 are energized.

In a modification of the above embodiments, the arresting of the machining unit 36 at the various pitch points of the rail segment may alternatively be effected by using the recess detector 112 to control pneumatic cylinders 114′ carrying clamping parts 116′, which cooperate non-positively with one of the surfaces of the rail segment 10, e.g. with the bottom end face of the side walls 34, in the manner also illustrated in FIG. 4.

In order to be able to check the course of a rail segment 10 in segment longitudinal direction with regard to cornering behaviour, rise and fall and with regard to torsion of the running surface, the machining unit 36 at its rear end is provided with two marks 163, which are spaced apart in a direction at right angles to the drawing plane of FIG. 1 and are indicated diagrammatically in the form of crosshairs. The crosshairs visible in FIG. 1 have been rotated 90° about the vertical axis in order to be able to show them more clearly.

The marks 163 are picked up by an electronic camera 164, which is part of a camera unit denoted as a whole by 166, which is mounted in a fixed position onto the end of the parking segment 26. The camera unit 166 comprises an evaluation unit 168 which, roughly speaking, operates as follows: it evaluates the electrical image produced by the camera 164 pixel by pixel so as to determine the position of the points of intersection of the marks 163.

Taking into consideration the geometry of the marks and the inclination of the rail segment at the point where the machining unit 36 is actually situated (said inclination may be derived in zeroth approximation from the design data), the evaluation unit 168 calculates the position of the points where the extensions of the marks 160 cut the main wall 32 of the box section 12.

The coordinates thus determined are compared with the design data for the rail segment. The comparison reveals whether the corresponding portion of the rail segment does or does not lie within the permissible tolerance.

As already indicated above, in order to calculate the base points of the axes of the marks 163 the evaluation unit 168 has to know the slope of the rail segment at the respective inspection point. And in order to be able to retrieve the design data for the inspection point, the evaluation unit 168 has to know at which point of the rail segment the machining unit 36 is situated.

As already explained further above, the position of the machining unit 36 on the rail segment 10 may be determined by adding up corresponding output pulses of the arithmetic and control unit 154. The computer 160 has these data.

As is apparent from FIG. 9, the computer 160 is connected to a modem part 170, which is connected to an aerial 172 carried by the machining unit 36. In a manner known per se to the person skilled in the art, the entire arrangement is such that the data provided by the computer 160 are converted into serial representation and then modulated upon a carrier signal using one of the known modulation techniques (amplitude modulation, frequency modulation, pulse-duration modulation etc.). Correspondingly modulated RF signals are output by the aerial 172 and picked up by an aerial 174 forming part of the camera unit 166.

As is evident from FIG. 10, the evaluation unit 168 has an input-side modem part 176, which is connected to the aerial 174. Said modem part for the purposes of the description is simultaneously to comprise the circuits that effect the reconversion of the data communicated via the radio link into a representation advantageous for the data evaluation.

The signals thus recovered, which are associated with the position of the machining unit 36 on the rail segment 10, are passed to an evaluating computer 178. The latter is connected by a controllable interface 180 to the electronic camera 164. The evaluating computer 178 activates the interface 180 in each case for reading in a complete image whenever the evaluating computer receives a new position value for the machining unit 36 from the modem part 176.

The evaluating computer 178 then searches in the camera image for the points where the points of intersection of the marks 162 lie and stores said coordinates initially unaltered in a storage field 182 of a mass storage device denoted as a whole by 184. The latter moreover contains in a further storage field 186 the design data of the respective rail segment 10 being machined and scanned.

In a further storage field 188 the evaluating computer 178 stores the points of intersection of the axes of the marks 162 with the main wall 32 that it has calculated from the mark coordinates in the manner described above.

Where required, the evaluating computer 178 may calculate the deviation of the measured inspection points from the design data of the rail segment and either file the result in a further storage field 190 of the mass storage device 184 or make said result available at a printer 192 or similar output medium or communicate said result via a further modem part 194 to a central production computer (not shown).

In the embodiment described above, the machining unit 36 was simultaneously an inspection unit. Scanning of the rail segment may be effected simultaneously with the production of the various grooves and bores.

Alternatively, an inspection unit that is independent of the machining unit may be used to scan rail segments.

Such an inspection unit may be of a substantially similar construction to that described above with reference to the machining unit 36, except that the milling unit 38 and the drilling unit 42 are omitted.

It is self-evident that such an inspection unit may then be of a far lighter design because such an inspection unit need not carry heavy units such as the milling heads and drilling heads nor has to absorb reaction forces of the type used for machining heads that are to be pressed against a workpiece.

From the above description of scanning of the rail segment 10 using the machining unit 36 that is simultaneously an inspection unit it emerged that a conversion of the position coordinates of the marks 163 to the coordinates of measuring points, aligned with their axes, on the main wall 32 is necessary. Such a conversion is considerably simplified when the points of intersection of the marks are situated in the running plane predefined by the plane tangential to the support rollers 80. FIG. 11 is a diagrammatic view of a corresponding inspection unit 36′.

Determination of the coordinates of the inspection points is further simplified if it is possible to place the marks directly onto the surface of the rail segment that is to be scanned. FIG. 12 indicates a possible way of doing this.

The support wheels 80 are designed with a peripheral surface in the shape of a truncated cone. Thus, a contact region of the running wheels 80 with the running wall 32 that is reduced to a point is achieved. And said contact point and/or the portion of the wheel edge adjacent to it may together with the top of the main wall 32 serve as a mark just as well as a mark placed onto the outside of the inspection unit 36′ (FIG. 11).

It is self-evident that the clearance between the underside of the inspection unit 36′ and the external contour of the rail segment is selected large enough for the edges of the support rollers 80 to remain clearly visible also when the inspection unit 36′ is being moved over an ascending or descending portion of the rail segment 10.

In the embodiment according to FIG. 12 the laterally disposed guide rollers 82 are also provided with an outer surface in the shape of a truncated cone, so that the contact point between the guide rollers 82 and the side walls 34 may likewise be used as a mark.

1. Apparatus for scanning a rail segment for a magnetic levitation system, characterized by a bearing device (16, 18, 20, 24) for the rail segment (10), by an inspection unit (36; 36′), which is movable in a guided manner along the rail segment (10) and carries at least one mark (163; 80; 82), by a camera (164), which generates an image of the marks (182; 80; 82), and by a distance measuring device (40), which determines the respective distance of the inspection unit (36) from a predetermined reference point of the rail segment (10), in particular from an end of the rail segment.

2. Apparatus according to claim 1, characterized in that the marks (163; 80; 82) project beyond the clear contour of the inspection unit (36; 36′).

3. Apparatus according to claim 1 or 2, characterized in that the marks (163; 80; 82) lie in a running plane, which is predefined by guide means (80; 82) of the inspection unit (36) that cooperate with a guide surface (32) of the rail segment (10).

4. Apparatus according to claim 3, characterized in that the marks are formed by tapering edge portions of guide means (80; 82).

5. Apparatus according to one of claims 1 to 4, characterized in that the marks (163; 80; 82) lie near one of the ends of the inspection unit (10).

6. Apparatus according to one of claims 1 to 5 for use by rail segments (10), which are provided with recesses (68-72) disposed at regular intervals, characterized in that the inspection unit (36; 36′) has a positioning unit (40), by means of which the inspection unit (10) is alignable with one of the recesses (68-72), and that the marks (163; 80; 82) are disposed preferably in a transverse plane predefined by the positioning device (40).

7. Apparatus according to claim 6, characterized in that the positioning device has a positioning part (116), which is movable positively into a recess (68-72) or has clamping means (114′, 116′) cooperating non-positively with the rail segment (10).

8. Apparatus according to claim 7, characterized in that the positioning part (116) is movable into a recess (68-72) by means of a servomotor (114).

9. Apparatus according to one of claims 1 to 8, characterized in that the distance measuring device (40) has a position sensor (112, 154, 160) or an incremental encoder (112, 154), which is carried by the inspection unit (36).

10. Apparatus according to claim 9, characterized in that the output signal of the position sensor (112, 154, 160) is connected by a wireless modem (170, 176) to an evaluation unit (168), which further receives the output signal of an image converter of the camera (164).

11. Apparatus according to claim 10, characterized in that the inspection unit (36) is intermittently moved on by one pitch or a multiple of the pitch of the recesses (68-72) and the evaluation unit (168) acquires (180) an image from the camera (164) in each case after the inspection unit (36) has been moved on to the next inspection point.

12. Apparatus according to one of claims 1 to 11, characterized in that the inspection unit is part of a machining unit (36), which comprises at least one machining head (98; 106) for the cutting of material and has an undercarriage (78-62), which is movable along the rail segment (10), wherein at least one positioning means (16; 112) is provided, which may cooperate with recesses (68-72) provided in the workpiece (10), in particular in that said positioning means is movable between an operating position cooperating with recesses (68-72) provided in the rail segment (10) and an idle position raised off the workpiece (10).

13. Apparatus according to one of claims 1-12 for use with a rail segment (10), which has a main wall (32) with a substantially horizontal extension component and two side walls (34) with a substantially vertical extension component, characterized in that guide means (82) facing the side walls (34) are displaceable in a transverse direction parallel to the main wall (32) and are preloaded in the direction of the adjacent side wall (34) in each case by identically constructed preloading devices (84, 86).

14. Apparatus according to claim 13, characterized in that the preloading devices have springs, in particular cup spring stacks (82).

15. Apparatus according to claim 13 or 14, characterized in that the preloading devices have pneumatic cylinders (86), which are loaded with compressed air via at least one pressure regulator (88).

16. Apparatus according to claim 15, characterized in that one pressure regulator (88) is provided for each of the pneumatic cylinders (86) associated with the two side walls (34).

17. Apparatus according to claim 16, characterized in that the pressure regulators (88) are controllable in terms of their control pressure and a signal, which is associated with the inclination of the main wall (32) relative to the horizontal, is applied to their control outputs.

18. Apparatus according to claim 17, characterized in that the pressure regulator control signals are derived from an inclination sensor (96) carried by the undercarriage (78-82).

19. Apparatus according to claim 17, characterized in that the pressure regulator control signals are derived from a position sensor (112, 154, 160), which is carried by the vehicle and which provides a signal corresponding to the instantaneous distance of the machining unit (36) from the end of the rail segment (10).

20. Apparatus according to one of claims 12-19, characterized in that the machining unit (36) carries an operation controller (160), which controls the operation of the working heads (98; 106) and of the positioning means (40) in dependence upon characteristic data of the rail segment (10), which are filed in a mass storage device (162) cooperating with the operation controller (160), or carries a modem part, via which there is a connection to a space-fixed operation controller of such a type.

21. Apparatus according to one of claims 12-20, characterized in that the working heads include at least one milling machine (98), which is displaceable (100) in transverse direction to the longitudinal axis of the rail segment (10).

22. Apparatus according to one of claims 12-21, characterized in that the working heads include at least one drilling machine (106).

23. Apparatus according to one of claims 12-22, characterized in that the machining unit (36) carries a plurality of milling machines (98) and/or drilling machines (106), which are disposed successively at identical intervals in longitudinal direction of the rail segment (10).

24. Apparatus according to claim 23, characterized in that the milling machines (98) and the drilling machines (106) are combined into groups.

25. Apparatus according to claim 24, characterized in that the groups of milling machines (98) and the group of drilling machines (106) are carried by independent undercarriages, which are connected to one another by joints, preferably by cardan joints or ball-and-socket joints (152).

26. Apparatus according to one of claims 12-25, characterized in that the positioning means (40) are carried by a separate undercarriage, which is connected (152) flexibly to another undercarriage.

27. Apparatus according to claim 25 or 26, characterized in that the hinge points of the joints (152) lies at the height of the neutral axis of the portions of the rail segment (10) which are to be machined.

28. Apparatus according to one of claims 1-27, characterized by parking parts (26, 28), which are situated near the ends of the rail segment (10) and have boundary surfaces, which at least in the surface regions cooperating with the guide means (82, 84) are a uniform smooth continuation of the boundary surfaces of the rail segment (10).

29. Apparatus according to claim 28, characterized in that the parking parts (26, 28) have identical cross sections and an identical construction to portions of the workpiece (10).

30. Apparatus according to claim 27 or 28, characterized in that the parking parts (26, 28) are carried by base units (30), which have fastening parts (146) that are adjustable in height and/or inclination.

31. Apparatus according to claim 30, characterized in that the base units (30) for the parking parts (26, 28) are of a substantially identical construction to the base units (24) used to support the rail segment (10).
